(19) United States
(12) Patent Application Publication
(10) Pub. No.: US 2025/0158144 A1
(43) Pub. Date: May 15, 2025

(54) BATTERY MODULE AND BATTERY PACK

(71) Applicant: TOYOTA JIDOSHA KABUSHIKI KAISHA, Toyota-shi (JP)

(72) Inventors: Tomoya MESUDA, Nisshin-shi (JP); Seigo FUJISHIMA, Miyoshi-shi (JP); Yoshiro OBAYASHI, Toyota-shi (JP); Kosuke SUZUKI, Toyota-shi (JP); Takeru HARA, Toyota-shi (JP); Satoshi MORIYAMA, Nagoya-shi (JP); Kenta MIYAHARA, Toyohashi-shi (JP)

(73) Assignee: TOYOTA JIDOSHA KABUSHIKI KAISHA, Toyota-shi (JP)

(21) Appl. No.: 18/789,676

(22) Filed: Jul. 31, 2024

(30) Foreign Application Priority Data
Nov. 9, 2023 (JP) 2023-191798

(51) Int. Cl. H01M 10/48; B60L 50/64; H01M 50/211

(52) U.S. Cl. CPC H01M 10/482; H01M 50/211; B60L 50/64

(57) ABSTRACT

The battery module includes an elongated battery cell composed of an electrode assembly sealed by a laminated film, a case capable of accommodating a battery cell group in which a plurality of battery cells is arranged, and a strain sensor provided in at least one of the battery cell and the case and capable of detecting strain.

### CROSS-REFERENCE TO RELATED APPLICATION

This application claims priority to Japanese Patent Application No. 2023-191798 filed on Nov. 9, 2023, incorporated herein by reference in its entirety.

### BACKGROUND

### 1. Technical Field

The present disclosure relates to battery modules and battery packs.

### 2. Description of Related Art

US Unexamined Patent Application Publication No. 2018/287184 discloses a battery module in which an electrode assembly is housed in a case. The electrode assembly (battery cells) are surrounded by a heat-shrinkable protective layer to reduce thermal expansion of the electrode assembly.

### SUMMARY

Although the thermal expansion and contraction states of battery cells can be indirectly detected based on information, such as a voltage, output from a battery module, there is room for improvement from the viewpoint of improving detection accuracy.

In view of the above, it is an object of the present disclosure to provide a battery module and a battery pack that can allow accurate detection of the thermal expansion and contraction states of battery cells.

A battery module according to claim 1 includes:
an elongated battery cell composed of an electrode assembly sealed by a laminated film; a case configured to house a battery cell group composed of an arrangement of a plurality of the battery cells; and
a strain sensor configured to detect strain and provided on either or both of the battery cell and the case.

In the battery module according to claim 1, the elongated battery cell is composed of the electrode assembly sealed by the laminated film. The case is configured to house the battery cell group composed of an arrangement of the battery cells. The strain sensor configured to detect strain is provided on either or both of the battery cell and the case. This allows to directly detect the thermal expansion and contraction state of the battery cell by acquiring a signal from the strain sensor during thermal expansion and contraction.

In a battery module according to claim 2, in claim 1,
the case may include a pair of short side wall portions extending in a stacking direction of the battery cells, and a pair of long side wall portions connecting the short side wall portions, and
the strain sensor may be provided at least at a middle portion of the long side wall portion.

In the battery module according to claim 2, the case includes the pair of short side wall portions and the pair of long side wall portions. The strain sensor is provided at least at the middle portion of the long side wall portion. The long side wall portion is subjected to larger displacement during thermal expansion and contraction than the short side wall portion, and the middle portion of the long side wall portion is subjected to larger displacement during thermal expansion and contraction than end portions of the long side wall portion. Therefore, providing the strain sensor at the middle portion of the long side wall portion that is subjected to large displacement during thermal expansion and contraction allows accurate detection of the thermal expansion and contraction state.

In a battery module according to claim 3, in claim 2,
the long side wall portion may have such a shape that the long side wall portion is curved inward in a longitudinal middle portion of the long side wall portion.

In the battery module according to claim 3, the long side wall portion is curved inward in its longitudinal middle portion. Therefore, providing the strain sensor at the longitudinal middle portion of the long side wall portion reduces or eliminates interference of the strain sensor with peripheral components.

In a battery module according to claim 4, in claim 1,
the strain sensor may be provided at least at a longitudinal middle portion of the battery cell.

In the battery module according to claim 4, the strain sensor is provided at the longitudinal middle portion of the battery cell. This allows to directly detect the thermal expansion and contraction state of the battery cell by acquiring a signal from the strain sensor.

In a battery module according to claim 5, in claim 1,
the battery cell may include a housing portion that houses the electrode assembly, and
the strain sensor may be provided at least at an end portion of the housing portion.

In the battery module according to claim 5, the battery cell includes the housing portion that houses the electrode assembly. The strain sensor is provided at the end portion of the housing portion. Since the end portion of the housing portion is a portion that will be subjected to large displacement during thermal expansion and contraction of the battery cell, providing the strain sensor at this portion allows accurate detection of the thermal expansion and contraction state.

A battery pack according to claim 6 includes
an arrangement of a plurality of the battery modules according to any one of claims 1 to 5.

The battery pack according to claim 6 includes the plurality of battery modules. This allows to grasp the thermal expansion and contraction states of the plurality of battery modules.

As described above, the battery module and battery pack according to the present disclosure allow accurate detection of the thermal expansion and contraction states of battery cells.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a main part of a vehicle to which a battery pack according to a first embodiment is applied;

FIG. 2 is a schematic perspective view of a battery module;

FIG. 3 is a schematic view of a battery cell accommodated in a battery module as viewed from a thickness direction;

FIG. 4A is a plan view of a state of a battery module with a top cover removed;

FIG. 4B is a plan view of a state of a battery module in a thermally expanded condition;

FIG. 5A is a schematic view of a battery cell according to a first modification;

FIG. 5B is a schematic view showing a battery cell according to a second modification; and

FIG. 6 is a plan view of a battery module according to a third modification in a state in which an upper lid is removed.

### DETAILED DESCRIPTION OF EMBODIMENTS

### First Embodiment

The battery module 11 according to the first embodiment will be described with reference to the drawings.

### Overall Configuration of Vehicle 100

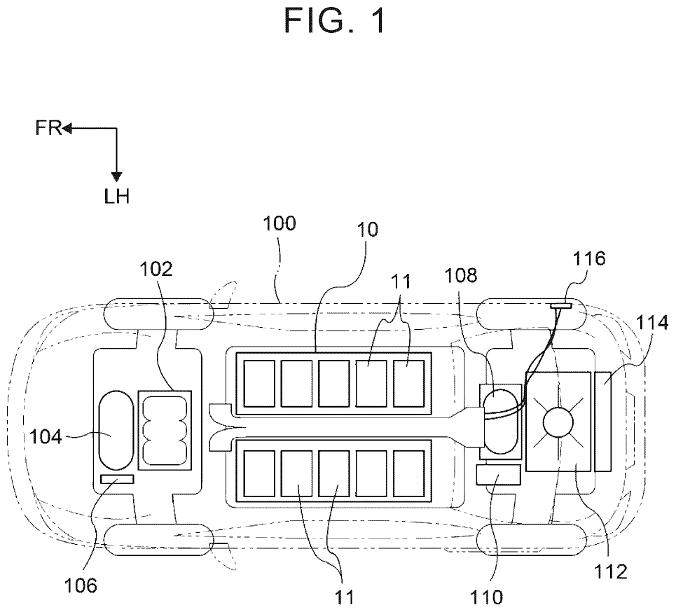

FIG. 1 is a schematic plan view showing a main part of a vehicle 100 to which a battery pack 10 according to the present embodiment is applied. As illustrated in FIG. 1, the vehicles 100 are battery electric vehicle (BEV) in which the battery pack 10 is mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressors 104, and PTC (Positive Temperature Coefficient) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverters 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

Note that the arrangement, structure, and the like of the components constituting the vehicle 100 are not limited to the above-described configurations. For example, it may be applied to an engine-mounted hybrid electric vehicle (HV) or plug-in hybrid electric vehicle (PHEV). Further, in the present embodiment, the motor 108 is a rear-wheel-driven vehicle mounted on the vehicle rear portion, but the present disclosure is not limited thereto, and the motor 108 may be a front-wheel-driven vehicle mounted on the vehicle front portion, or a pair of motors 108 may be mounted on the vehicle front and rear. Further, the vehicle may be provided with an in-wheel motor for each wheel.

Here, the battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

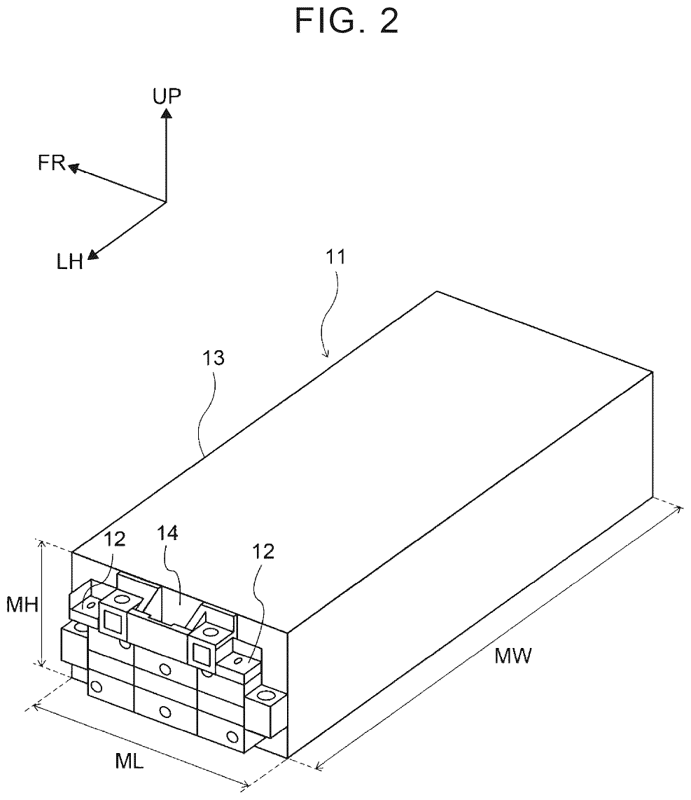

FIG. 2 is a schematic perspective view of the battery module 11. As shown in FIG. 2, the battery module 11 is formed in a substantially rectangular parallelepiped shape whose longitudinal direction is the vehicle width direction. The case 13 of the battery module 11 is made of an aluminum alloy. For example, the case 13 of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 21, which will be described later, is connected to the connector 14. A bus bar (not shown) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

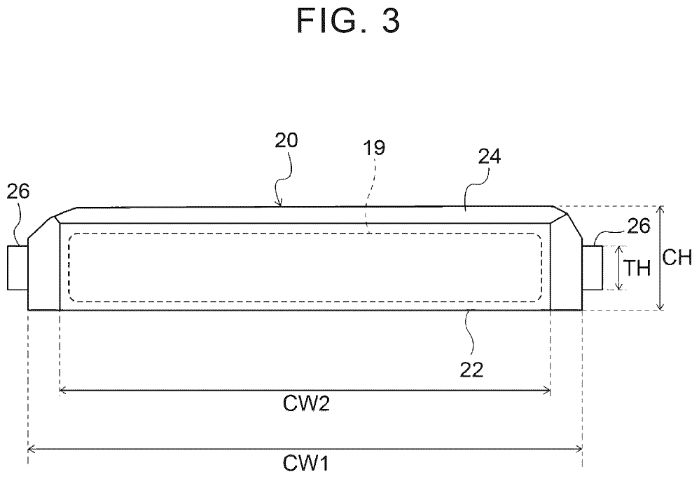

FIG. 3 is a schematic view of the battery cell 20 accommodated in the battery module 11 as viewed from the thickness direction. As shown in FIG. 3, the battery cell 20 is formed in a substantially rectangular plate shape, and an elongated electrode assembly 19 is accommodated therein. The electrode assembly 19 is formed by laminating a positive electrode, a negative electrode, and a separator, and is sealed with a laminated film 22.

In the present embodiment, as an example, the embossed sheet-like laminated film 22 is folded and bonded to form a housing portion of the electrode assembly 19. Although both of the single-cup embossed structure in which the embossing is performed at one place and the double-cup embossed structure in which the embossing is performed at two places can be adopted, in the present embodiment, the single-cup embossed structure has a drawing depth 8 mm to a 10 mm degree.

The upper ends of both end portions in the longitudinal direction of the battery cell 20 are bent, and the corners have an outer shape. Further, the upper end portion of the battery cell 20 is bent, and the fixing tape 24 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the middle in the vertical direction of the battery cell 20. The terminal 26 is joined to a bus bar (not shown) by laser welding or the like.

The vehicle-width-direction length CW1 of the battery cells 20 is, for example, 530 mm to 600 mm. The length CW2 of the area in which the electrode assembly 19 is accommodated is, for example, 500 mm to 520 mm. The height CH of the battery cell 20 is, for example, 80 mm to 110 mm. Therefore, the battery cell 20 is formed in an elongated shape, and the length CW1 and the direction of CW2 are the longitudinal direction.

Further, the thickness of the battery cell 20 is from 7.0 mm to 9.0 mm, and the height TH of the terminal 26 is 40 mm to 50 mm.

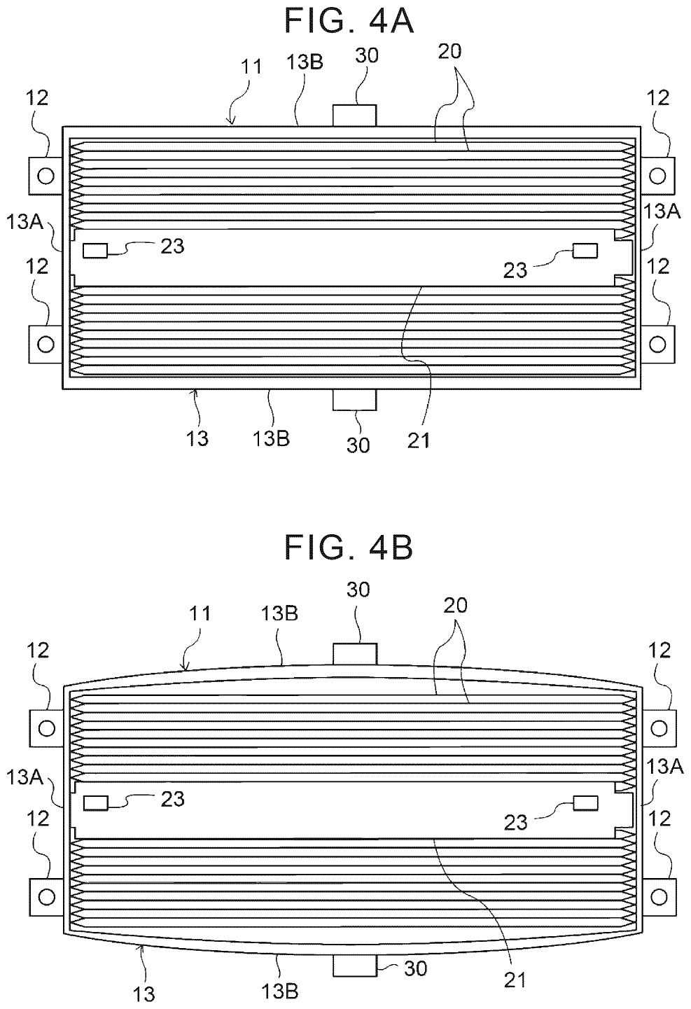

FIG. 4A is a plan view of a state in which an upper cover of a battery module 11 is removed. As shown in FIG. 4A, a battery cell group in which a plurality of battery cells 20 are arranged is accommodated in the battery module 11. In the present embodiment, as an example, 24 battery cells 20 are arranged in the vehicle front-rear direction and adhered to each other.

A flexible printed circuit board (FPC: Flexible Printed Circuit) 21 is disposed on the battery cell 20. The flexible printed circuit board 21 is formed in a band shape with the vehicle width direction as a longitudinal direction, and thermistors 23 are provided at both end portions of the flexible printed circuit board 21. The thermistor 23 is not adhered to the battery cell 20 and is pressed toward the battery cell 20 by the upper lid of the battery module 11.

One more buffer plates (not shown) are accommodated in the battery module 11. For example, the buffer plate is an elastically deformable thin plate-shaped member, and is disposed between the adjacent battery cells 20 with the arrangement direction of the battery cells 20 as the thickness direction. In the present embodiment, as an example, cushioning materials are disposed at both end portions in the longitudinal direction of the battery module 11 and at a longitudinal middle portion, respectively.

Here, a strain sensor 30 capable of detecting strain is provided in the case 13 of the battery module 11. Specifically, the case 13 includes a pair of short side wall portions 13A extending along the stacking direction of the battery cells 20, and a pair of long side wall portions 13B connecting the short side wall portions 13A to each other.

The strain sensor 30 is provided at least at a middle portion of the case 13 on the long side wall portion 13B. In the present embodiment, for example, it is provided at middle portions in the longitudinal direction and height direction of the long side wall portion 13B. Further, the strain sensor 30 of the present embodiment is provided in each of the pair of long side wall portions 13B.

The strain sensor 30 uses, for example, a sensor that utilizes a principle that the resistance value changes due to the expansion and contraction of the resistance body in proportion to the expansion and contraction of the measurement object by adhering to the measurement object via an electrical insulator. Further, a lead wire (not shown) is connected to the strain sensor 30, so that a signal output from the strain sensor 30 can be acquired by an external device.

FIG. 4B is a plan view showing a state in which the battery module 11 is thermally expanded from the state shown in FIG. 4A. For convenience of explanation, the expansion of the case 13 is exaggerated. As shown in FIG. 4B, when the battery cell 20 thermally expands, the long side wall portion 13B of the case 13 expands because the battery cell expands in the thickness direction. At this time, by acquiring the signal output from the strain sensor 30, the thermal expansion and contraction state of the case 13 can be grasped.

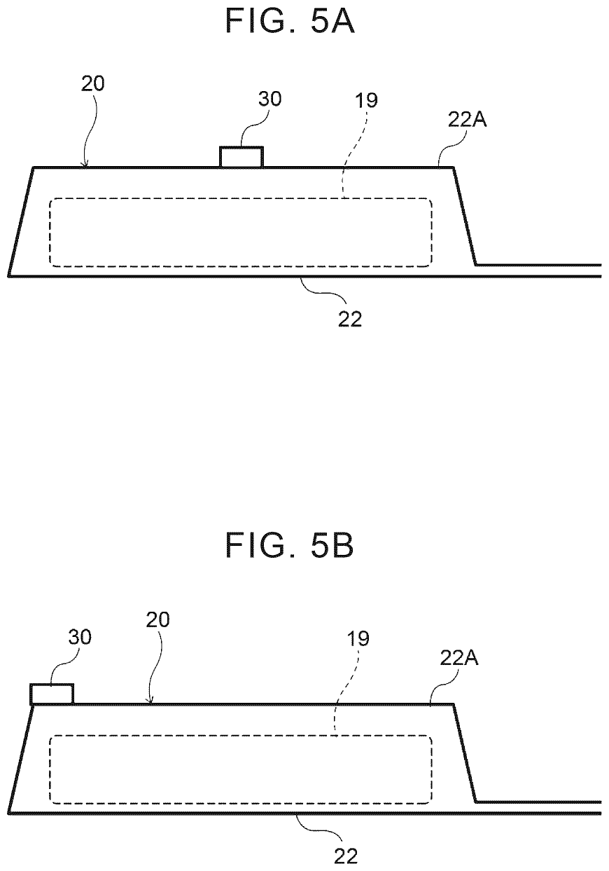

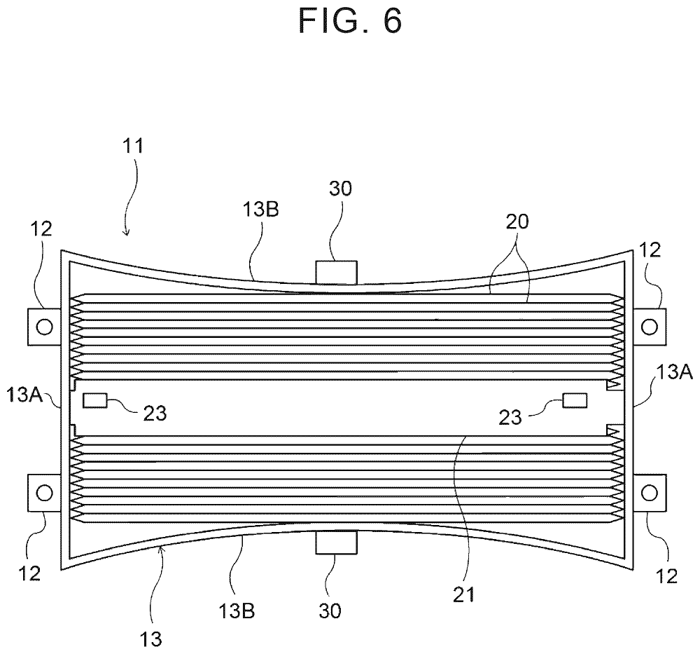

In the present embodiment, the strain sensor 30 is provided on the long side wall portion 13B of the case 13, but the present disclosure is not limited thereto, and the strain sensor 30 may be provided on the battery cell 20 as in the first modification and the second modification shown in FIGS. 5A and 5B. Further, as in the third modification shown in FIG. 6, the shape of the case 13 may be changed.

### First Modification

FIG. 5A is a schematic diagram showing a battery cell 20 according to a first modification. As shown in FIG. 5A, the laminated film 22 constituting the battery cell 20 has a single-cup embossing structure, and includes a housing portion 22A (embossing portion) that houses the electrode assembly 19.

A strain sensor 30 is provided at a longitudinal middle portion of the battery cell 20 in the housing portion 22A. By acquiring the signal from the strain sensor 30, the expansion state of the housing portion 22A can be grasped.

### Second Modification

FIG. 5B is a schematic diagram showing a battery cell 20 according to a first modification. As shown in FIG. 5B, in the present modification, the strain sensor 30 is provided at the end portion of the housing portion 22A. That is, the strain sensor 30 is provided at a shoulder portion of the embossing cup.

### Third Modification

FIG. 6 is a plan view of a battery module according to a third modification in a state in which an upper lid is removed. As shown in FIG. 6, in the present modification, the long side wall portion 13B of the case 13 is recessed. Specifically, the long side wall portion 13B is formed so as to be curved inward in its longitudinal middle portion. In addition, a strain sensor 30 is provided at a longitudinal middle portion of the long side wall portion 13B.

In the present modification example, since the strain sensor 30 is provided in the recessed portion, even when a plurality of the battery modules 11 are arranged, interference of the strain sensor 30 with the adjacent battery modules can be suppressed.

### Action

Next, operations of the battery pack 10 and the battery module 11 according to the present embodiment will be described.

In the battery module 11 according to the present embodiment, as shown in FIG. 3, an elongated battery cell 20 is formed by sealing the electrode assembly 19 with the laminated film 22. As shown in FIG. 4A, the case 13 is configured to accommodate a battery cell group in which a plurality of battery cells 20 are arranged. Further, the case 13 is provided with a strain sensor 30 capable of detecting strain. Thus, the thermal expansion and contraction state of the battery cell 20 can be directly detected by acquiring a signal from the strain sensor 30 at the time of thermal expansion and contraction. As a result, the thermal expansion and contraction state of the battery cell 20 can be accurately detected. In the battery pack 10, a plurality of battery modules 11 are arranged. Thus, the thermal expansion and contraction states of the plurality of battery modules 11 can be grasped.

Further, in the present embodiment, the case 13 includes a pair of short side wall portions 13A and a pair of long side wall portions 13B, and the strain sensor 30 is provided at least at a middle portion of the long side wall portion 13B. Here, as shown in FIG. 4B, the displacement due to the thermal expansion and contraction is larger in the long side wall portion 13B than in the short side wall portion 13A, and the displacement in the middle portion is larger than in the end portions in the long side wall portion 13B. Thus, by providing the strain sensor 30 in the middle portion of the long side wall portion 13B is large displacement due to thermal expansion and contraction, it is possible to detect the thermal expansion and contraction condition accurately.

Further, in the first modification, as shown in FIG. 5A, since the strain sensor 30 is provided in the longitudinal middle portion of the battery cell 20, the thermal expansion and contraction of the battery cell 20 can be directly detected by acquiring a signal from the strain sensor 30.

On the other hand, in the second modification, as shown in FIG. 5B, the strain sensor 30 is provided at the end portion of the battery cell 20 on the housing portion 22A. Here, the end portion of the housing portion 22A, that is, the shoulder portion of the embossed cup, is a portion that is large in displacement during thermal expansion and contraction of the battery cell 20, and therefore, by providing the strain sensor 30 at this portion, the thermal expansion and contraction condition can be accurately detected.

Further, in the third modification, as shown in FIG. 6, the long side wall portion 13B of the case 13 is curved inward in its longitudinal middle portion. Therefore, by providing the strain sensor 30 at the middle portion, the strain sensor 30 does not need to interfere with peripheral components such as the adjacent battery module.

Although the battery pack 10 and the battery module 11 according to the embodiment have been described above, it is needless to say that the present disclosure is not limited thereto and can be implemented in various forms without departing from the gist of the present disclosure. For example, in the above embodiment, the strain sensor 30 is provided in the middle portion in the height direction in the long side wall portion 13B, but the present disclosure is not limited thereto, and the position in the height direction in which the strain sensor 30 is attached may be changed.

Further, as the strain sensor, strain sensors of various configurations can be used as long as the strain sensor can detect strain in the case 13 and the battery cell 20.

Further, the strain sensor 30 may be provided in both the case 13 and the battery cell 20. In this case, the strain sensor provided in the case 13 and the strain sensor provided in the battery cell 20 may be different types of sensors. For example, the strain sensor provided in the battery cell 20 may have a thinner shape.

Furthermore, although the single-cup embossing structure is adopted in the above embodiment, the present disclosure is not limited thereto and may be applied to a battery cell having a double-cup embossing structure. In this case, the thermal expansion state of the battery cell can be detected by providing a strain sensor in one or both of the embossing cups.

With respect to the above embodiments, the following supplementary notes are disclosed.

### APPENDIX 1

A battery module comprising:
an elongated battery cell composed of an electrode assembly sealed by a laminated film;
a case configured to house a battery cell group composed of an arrangement of a plurality of the battery cells; and
a strain sensor configured to detect strain and provided on either or both of the battery cell and the case.

### APPENDIX 2

The battery module according to Appendix 1, wherein
the case includes a pair of short side wall portions extending along the stacking direction of the battery cells, and a pair of long side wall portions connecting the short side wall portions, and
the strain sensor is provided at least in a middle portion of the long side wall portion.

### APPENDIX 3

The battery module according to Appendix 1 or 2, wherein the long side wall portion has such a shape that the long side wall portion is curved inward in a longitudinal middle portion of the long side wall portion.

### APPENDIX 4

The battery module according to any one of Appendices 1 to 3, wherein the strain sensor is provided at least at a longitudinal middle portion of the battery cell.

### APPENDIX 5

The battery module according to claim 4, wherein
the battery cell includes a housing portion for housing the electrode assembly, and
the strain sensor is provided at least at an end portion of the housing portion.

### APPENDIX 6

A battery pack configured by arranging a plurality of battery modules according to any one of Appendices 1 to 5.

What is claimed is:

1. A battery module, comprising:
an elongated battery cell composed of an electrode assembly sealed by a laminated film;
a case configured to house a battery cell group composed of an arrangement of a plurality of the battery cells; and
a strain sensor configured to detect strain and provided on either or both of the battery cell and the case.

2. The battery module according to claim 1, wherein
the case includes a pair of short side wall portions extending in a stacking direction of the battery cells, and a pair of long side wall portions connecting the short side wall portions, and
the strain sensor is provided at least at a middle portion of the long side wall portion.

3. The battery module according to claim 2, wherein the long side wall portion has such a shape that the long side wall portion is curved inward in a longitudinal middle portion of the long side wall portion.

4. The battery module according to claim 1, wherein the strain sensor is provided at least at a longitudinal middle portion of the battery cell.

5. The battery module according to claim 4, wherein
the battery cell includes a housing portion that houses the electrode assembly, and
the strain sensor is provided at least at an end portion of the housing portion.

6. A battery pack comprising an arrangement of a plurality of the battery modules according to claim 1.
